(19) United States
(12) Patent Application Publication
(10) Pub. No.: US 2009/0139078 A1
(43) Pub. Date: Jun. 4, 2009

(54) Methods and manufacturing systems for manufacturing parts, utilizing geometrical free spaces of manufacturing machines

(75) Inventors: Carl Johannes Fruth, Parsberg (DE); Alexander Oster, Parsberg (DE)

Correspondence Address: SIMPSON & SIMPSON, PLLC, 5555 MAIN STREET, WILLIAMSVILLE, NY, 14221-5406, US

(73) Assignee: FIT Fruth Innovative Technologien GmbH, Parsberg (DE)

(21) Appl. No.: 12/315,054

(22) Filed: Nov. 26, 2008

(30) Foreign Application Priority Data
Nov. 30, 2007 (DE) 10 2007 057 803.4

(51) Int. Cl. B23P 17/00; G06F 19/00

(52) U.S. Cl. 29/592; 700/95; 29/650

(57) ABSTRACT

A method for manufacturing a first part and a further part in a manufacturing machine including a construction space for manufacturing parts, the method including the steps of providing position and contours of the first part positioned in the construction space as digital first part data, providing digital construction space data representing the construction space, providing the digital first part data and the digital construction space data to a potential ordering party for displaying the first part in the construction space, receiving digital second part data representing the further part and its position in the construction space, virtual positioning of at least one other part which was not yet commissioned in the displayed construction space, and manufacturing the at least one first part and the at least one further part in the manufacturing machine.

### CROSS-REFERENCE TO RELATED APPLICATIONS

This patent application claims priority from German Patent Application No. 10 2007 057 803.4, filed Nov. 30, 2007, which application is incorporated herein by reference.

### FIELD OF THE INVENTION

The present invention relates to various methods and manufacturing systems for manufacturing parts by utilizing geometrical free spaces on manufacturing machines. Moreover, the invention relates to an anonymization method that is preferred, for example, for an above-mentioned method, in order to show third parties solely an anonymized or deform version of parts or workpieces to be manufactured in said manufacturing system

### BACKGROUND OF THE INVENTION

Presently, a variety of manufacturing machines are used for the manufacturing of products or parts that have certain defined construction spaces. Due to the type of manufacturing method, one or several parts can often be manufactured in the construction spaces of these manufacturing machines in a single production run. These methods include, for example, all known rapid prototyping and rapid manufacturing methods and, generally, all currently known manufacturing machines that can be subsumed under the term of “Freeform Fabrication”. Manufacturing machines, which are capable of directly manufacturing three-dimensional parts on the basis of 3D-CAD-data can, for example, be configured for this kind of methods or manufacturing machines.

The above-mentioned methods and manufacturing machines, which are also termed layered manufacturing systems, are in particular used for swift and economic manufacturing of prototypes or small series. Previously, industrially deployed Rapid Prototyping and Rapid Manufacturing systems have mainly been used for manufacturing organic material parts like polymers and waxes. Systems of this kind are, however, also increasingly used in manufacturing metal or ceramic parts. Metal parts are, in particular, produced via the melting phase by what is known as laser melting/sintering or electron beam melting.

The common feature of all known systems of the above mentioned kind is the layer composition of the work piece. For this purpose, 3D-CAD-data is usually split up into a plurality of single layers or vertical sections, which are used for the composition of the workpiece in the ultimate manufacturing process. This means that all known layered manufacturing systems for manufacturing three-dimensional bodies require the body-contour data for each layer. Here, the body-contour data is the data which exactly defines those portions of the respective layer, and which portions have to be exposed to light, printed, melted or sintered, depending on the kind of layered manufacturing technology used.

The layer composition method used for the present invention may include the following methods: 3DP of Zcorp, PLT of Kira, Polyjet of Object, SMS of Sintermask, SLS and DMLS of EOS, SLA and IMLS of 3D Systems, Lasercusing of Konzeptlaser, Laserschmelzen of MCP, Electron Beam Melting of Arcam and Electron Beam Sintering.

Usually, a client places an order for the manufacturing one or several parts with a plant or company (service provider). The service provider then decides which of the manufacturing machines is suitable for manufacturing the desired parts. Hereafter, a job is created, which job, if possible, comprises one or several parts in a defined construction space of the manufacturing plant and may also comprise parts of different customers. As soon as the parts are virtually positioned in the available construction space of the manufacturing machine, manufacturing is usually started. Although it is desired in this kind of manufacturing machines that the load factor in a construction space is as high as possible, it often is not possible to maximise the load factor, as the ordering parties or clients wish to have the parts manufactured up to a fixed date. For this reason it is often impossible to optimally exploit each manufacturing machine and the respective installation spaces, as often, it is not possible to wait until the free space remaining in the respective installation space of a manufacturing plant can be filled up with further parts of a different customer. This problem also results in that the fabrication price of a part, which price the client has to pay, is merely calculated on the basis of the parts requested of this client.

As general background, DE 102 25 854 A1, DE 10 205 014 979 A1, and U.S. 2008/0109105 A1 are identified, in which virtual part data may be used. In EP 1 031 392 B1, techniques for a control system in a selective deposition modelling system used for forming three-dimensional objects on substantially a layer-by-layer basis with enhanced resolution is disclosed. These techniques are directed primarily to selective deposition modelling object formation. However, it is mentioned that the techniques may have application in other RP&M technologies. According to one aspect, a rapid prototyping system comprises means for accepting multiple jobs to be placed in job queue, wherein each job comprises a request to build a three-dimensional object by at least one rapid prototyping apparatus. In addition, means for combining two or more jobs in one build process formed by the rapid prototyping apparatus are included. According to this disclosure, all of the jobs are arranged in a job queue. A user is being enabled to preview all of the jobs in the job queue. A particular user or client computer may be designated to be the only one with access to preview in all jobs. In one embodiment, a user may only preview jobs that the user submitted.

A problem of the method and device disclosed in EP 1 031 392 B1 may be that jobs have to be submitted by the user to the system before these jobs may be combined. However, that might limit the user in getting all benefits of the system.

Another technical problem underlying the invention may be how to use one or several manufacturing machines with their respective defined and limited installation spaces more efficiently than has been the case up to now, in particular, how to increase the load factor of these machines.

A further technical problem of the present invention may be, how to visually show potential clients or ordering parties the installation spaces of the available manufacturing machines, together with the parts to be manufactured therein, without making information about the parts, in particular their specific shape and body structure, accessible to unauthorized third parties. This is especially the case with confidential prototypes.

### BRIEF SUMMARY OF THE INVENTION

According to a first aspect of the present invention, a method for manufacturing at least one additional part in a manufacturing machine is suggested, said manufacturing machine having a defined construction space for manufacturing one or several first parts. The method according to the present invention may comprise providing position and contours of at least one first part positioned in the construction space as digital first part data, providing digital construction space data representing the construction space, providing the digital first part data and digital construction space data representing the construction space to a potential ordering party for displaying the at least one first part in the construction space, receiving digital second part data representing at least one further part and its position in the construction space, the digital second part data being generated by displaying the construction space and the at least one first part and its position in the defined construction space and virtual positioning of at least one further part which was not yet commissioned in the displayed construction space, and manufacturing the at least one first part and the at least one further part in the manufacturing machine.

In the method according to the first aspect of the invention, the positions and contours of the first part(s) in the construction space of the manufacturing machine are detected or defined by means of their digital part data. In other words, the digital part data of the parts to be manufactured in the installation space are provided or collected. This digital first part data represents the position and the complete shape or design of the first part(s) in the construction space. According to the invention, this digital first part data and the digital construction space data representing the size of the construction space of a manufacturing machine are made available for a potential ordering party or user. According to the invention, it is now possible to determine the digital second part data representing at least one further part and its position in the construction space. This digital second part data is transmitted by the potential ordering party or user. As soon as it is determined that no further parts have to be inserted in the construction space, the at least one further part and the one or several first part(s) are manufactured in the manufacturing plant.

It has to be noted that the use of the term “first” parts merely serves to distinguish those parts, which have to be manufactured in the construction space and which have been virtually positioned, from the “further” parts, which are subsequently inserted into the installation space by third parties. Moreover, it has to be pointed out that in the present case, a real construction space of a manufacturing plant is discussed, when it is about the actual production of parts. In most of the other cases, e.g., the display of installation spaces or the insertion of parts into a construction space, it is referred to a “virtual” construction space, which usually is displayed to an ordering party or user in 3D. The same applies to the term “part”. The term “job”or “construction job”, which is also used here, is used for a virtual construction space and all the (virtual) parts (virtually) positioned therein.

The idea underlying the invention is to manufacture one or several construction spaces of one or several manufacturing machines together with the first parts already positioned therein, “accessible” for different potential clients or ordering parties for the first time ever. Due to the fact that the construction spaces loaded for each “job” with first parts are accessible for additional ordering parties, said parties may load available free spaces in the construction spaces of manufacturing machines loaded with first parts with further parts, whereby, for example, the time until delivery of the further parts may be shortened, as it is not necessary to wait until the construction job, i.e., the manufacturing of the first parts in the construction space, is completed. Furthermore, this enables the ordering parties to immediately check the production capacity up to a certain date. Moreover, the manufacturer may reduce the production costs per part, as several parts may now be manufactured in the same “job”.

In an exemplary embodiment of the present invention, the service provider may also stipulate that the production costs, which are actually lower due to the addition of one or several further parts, also result in a lower offer price for the production of the first and/or the further parts, and, in another exemplary embodiment of the present invention, the service provider may also transmit this cost advantage to the ordering party of the first parts and/or the ordering party of the further parts, if desired. In this way, the service provider may become more appealing to potential purchasers.

In a further exemplary embodiment of the method according to the invention, a computer-aided test step may be of advantage, wherein, by using the part data the software checks whether the remaining free space in the defined construction space of the manufacturing plant is sufficient to manufacture the at least one further part.

In a further exemplary embodiment of the method according to the invention, a visualisation step is integrated, which step allows for demonstrating the construction space and the first parts positioned therein to a potential ordering party, preferably in 3D.

In case that several manufacturing plants are available, an exemplary embodiment of the present invention may display these several manufacturing machines to a user, who then can choose a suitable manufacturing machine.

In a further exemplary embodiment of the present invention, it may be advantageous that, in case that one manufacturing machine has several installation spaces, or in case that several already loaded construction spaces, each displaying a job of this manufacturing machine, are available in a manufacturing machine, all jobs, i.e., construction spaces with first parts to be manufactured therein are visually displayed to the user, and that the user can choose the job that is best suited for his purposes.

In a further exemplary embodiment of the present invention, it may be advantageous to anonymize the first part data. According to the invention, the anonymized positional data and contour data of the first parts are made accessible for potential ordering parties, who are not the ordering parties of the first parts. This anonymization may be carried out by means of Voxeln, (volumetric pixelization), so that the entire body of a first part is split up into individual joined spatial individual segments. Due to the segmentation of a first part into individual segments, its appearance is slightly or highly changed, depending on the size and shape of the chosen segments. The Voxeln can be followed by “inflating”, i.e., the single Voxels or segments of a part are enlarged by a certain factor in one or several directions of a coordinate system, and thereby the whole body of the part is “inflated”. An anonymization of a first part may also be carried out by surrounding a first part with, for example, a cuboid-shaped or cube-shaped volume, which is only just large enough for the part. Of course, instead of a cuboid-shaped or cube-shaped volume, also any other geometrical volume shapes, as, for example, circles, cylinders, etc., can be chosen as “encasement” for a first part.

A further form of anonymization results from a change caused by production, e.g., from adding a support-volume, reinforcement of walls that are too thin to be manufactured, or locking of regions within parts, e.g., locking parts inside of a bottle, whereafter it may be impossible to remove these assembled parts from the bottle. Different kinds of anonymization may also be combined.

According to a further aspect of the present invention, a manufacturing system for manufacturing at least one first part and at least one further part may comprise at least one manufacturing machine having a defined construction space wherein parts can be manufactured, a distribution system, which is connected to the at least one manufacturing machine, the distribution system being configured to administrate digital data of construction spaces of each manufacturing machine and of digital first part data of at least one first part to be manufactured in a respective construction space, and a receiving device configured to receive digital further part data, the digital further part data representing the at least one further part and its position in the construction space and being generated by displaying the construction space and the at least one first part and its position in the defined construction space and virtual positioning of at least one further part which was not yet commissioned in the displayed construction space.

According to a further aspect of the present invention, a manufacturing system for manufacturing at least one first part in a manufacturing machine is created, which system comprises at least one manufacturing machine with a defined limited construction space, wherein one or several parts can be manufactured. A distribution system is connected to the at least one manufacturing machine. Consequently, all jobs to be manufactured at this manufacturing machine, that is, the digital data of the construction space of each manufacturing machine and the digital first part data of all parts to be manufactured in the respective construction spaces, are available to the distribution system. In other words, the distribution system comprises, for example, a server with a database, wherein all jobs for all manufacturing machines are administrated. It is therefore known, which construction space is “loaded” with which first parts for which job. The manufacturing system according to the invention comprises at least one user-terminal, which is connected to the distribution system and which, on request provides all available manufacturing machines with the respective jobs.

According to the invention, for the first time ever, jobs can be provided via commonly known communication channels, such as the internet. In this way, a potential ordering party can quickly and swiftly check if a required part can be manufactured at the desired point in time. In particular, it is also possible to immediately have checked, if the required part can be manufactured in a job, by inserting a part into an existing job. In an exemplary embodiment of the present invention it is also possible to have a cost calculating module, which may check and newly calculate the costs for said further part in a job on the basis of the first and additional parts that now have to be manufactured in this job. Thus, the potential ordering party may reduce the costs of the parts by adding further parts, if the system recalculates the manufacturing costs on the basis of the reduced free space.

Different cost functions with position evaluation can therefore not only evaluate the manufacturing cost but also other features, e.g., construction time, producible product quality or process stability on changing the “load” of the construction job. The evaluation of a part and therefore, amongst other things, its manufacturing costs can, for example, easily be calculated on the basis of the volume of the part.

In the above mentioned embodiments of the present invention, the visualisation of the first and further parts preferably is effected in three-dimensional display, utilizing common methods and devices like monitors, etc.

Manufacturing machines, whose costs are largely determined by the costs of material of the built up space or by other parts that are not dependent of the geometry of the parts, are particularly suited for the present method and system according to the invention. In particular, in so-called layer composition methods, loading problems for the respective installation spaces may arise. But also various other manufacturing machines are afflicted with certain loading problems and, therefore, with costs of the parts to be manufactured, where regularly a two- or three-dimensional packing problem, like laser cutting, occurs due to the shape of the part. One thing, all these manufacturing machines have in common is that the positioning of arbitrary parts causes considerable clearances in the construction space of such kind of manufacturing machine.

According to a further aspect of the invention, a manufacturing system for manufacturing at least one first part and at least one further part may comprise at least one manufacturing machine having a defined construction space wherein parts can be manufactured, a distribution system, which is connected to the at least one manufacturing machine, the distribution system being configured to administrate digital data of construction spaces of each manufacturing machine and of digital first part data of at least one first part to be manufactured in a respective construction space, a receiving device configured to receive digital further part data, the digital further part data representing the at least one further part and its position in the construction space and being generated by displaying the construction space and the at least one first part and its position in the defined construction space and virtual positioning of at least one further part which was not yet commissioned in the displayed construction space, and at least one user terminal being connected to the distribution system. The user terminal may comprise a displaying device configured to display, in particular in 3D display, one or several construction spaces with the at least one first part to be manufactured therein, an input device configured to position at least one further part into a construction space displayed by means of the displaying device, in which construction space the at least one first part is positioned, and a transmitting device configured to transmit the digital further part data.

Finally, according to a further aspect of the invention, a method for anonymization of at least one part positioned in a construction space of a manufacturing machine and ordered by a first ordering party may comprise providing position and contours of the at least one first part in the construction space as digital first part data, altering the digital first part data so that at least the contours of the at least one first part are anonymized and consequently rendering of the at least one first part is amended and at least real contours of the at least one first part are not available anymore, and making available the altered digital first part data to potential second ordering parties, the potential second ordering parties being not identical with the at least one first ordering party. Accordingly, the positioning and the contours of the first parts in the construction space are determined by means of their digital part data. Then a computer-aided anonymization of the first parts is carried out and the users are provided only with this data representing anonymized parts.

For the sake of completeness, it should be noted that second or further parts become first parts after they have been added to the construction job, and everything that has been said with regard thereto, e.g., the anonymization, is also valid for these formerly second parts, which now become first parts according to the chosen terminology.

These and other objects and advantages of the present invention will be readily appreciable from the following description of preferred embodiments of the invention and from the accompanying drawings and claims.

### BRIEF DESCRIPTION OF THE DRAWINGS

For the further explanation and for a better comprehension, several exemplary embodiments of the present invention are described and explained in the following, with reference to the attached drawings, in which:

FIG. 1 is a schematic illustration of parts of a manufacturing system according to a first exemplary embodiment of the present invention;

FIG. 2 is a flow-chart of an exemplary embodiment of a method according to the invention;

FIG. 3 is a flow-chart of a further exemplary embodiment of a method according to the invention;

FIG. 4 is a flow-chart of a further exemplary embodiment of the present invention;

FIG. 5 is a schematic illustration of a display on a monitor for a user for a method according to the invention;

FIG. 6 is a schematic illustration of a construction space of a manufacturing machine with first parts positioned therein;

FIG. 7 is a further schematic illustration of a construction space of a manufacturing machine according to FIG. 6, wherein the parts positioned therein are anonymized,

FIG. 8 is a schematic illustration of a display on a monitor for a user, wherein a construction space with first parts, and a further part that may be placed therein are shown;

FIG. 9 is a schematic illustration according to FIG. 8, wherein the further part is integrated into the construction space of FIG. 8;

FIG. 10 is a further schematic illustration similar to those of FIGS. 8 and 9, wherein several first and second parts are placed in a construction space of a manufacturing machine;

FIG. 11 is a further illustration of a virtual construction space with first and second parts in the construction space of a manufacturing machine;

FIG. 12 is a schematic illustration of a formula for the distance- and cost calculation of parts in a construction space;

FIG. 13 is a schematic overview of single elements of an exemplary embodiment of a manufacturing system according to the invention and data used therein;

FIG. 14 is a schematic overview of different modules of a manufacturing system according to the invention;

FIG. 15 is a further schematic overview of different modules of a manufacturing system according to the invention;

FIG. 16 is a further schematic overview of parts of a manufacturing system according to the invention; and,

FIG. 17 is a schematic overview of a possible organisation plan for different software and hardware modules for the realisation of one or several exemplary embodiments of the present invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

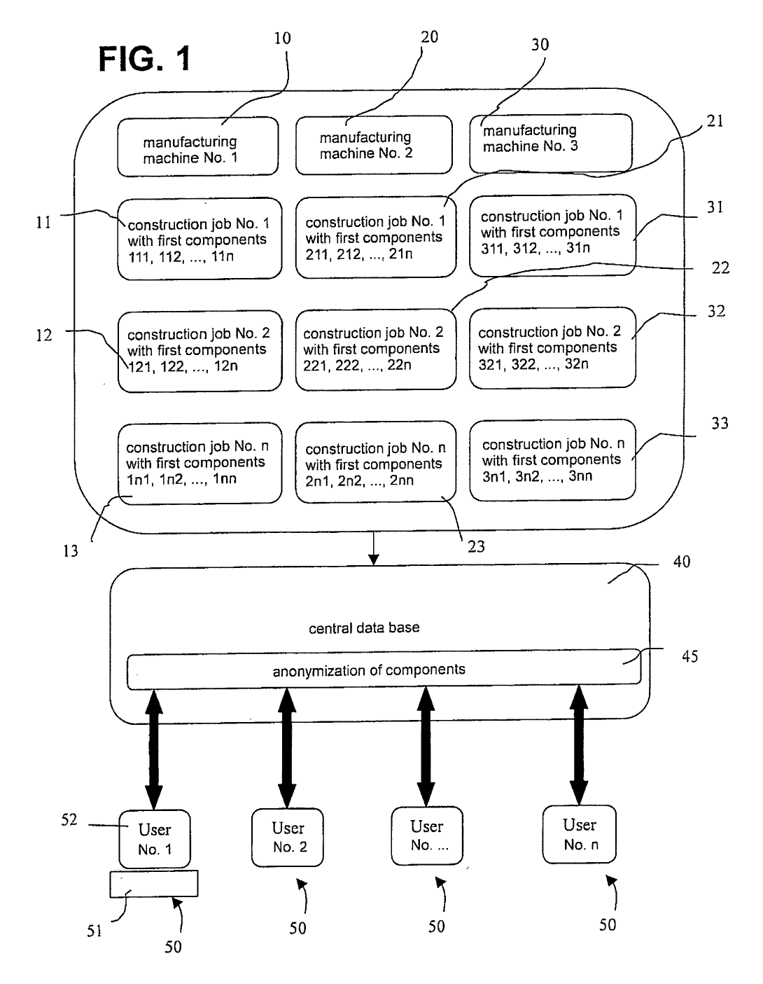

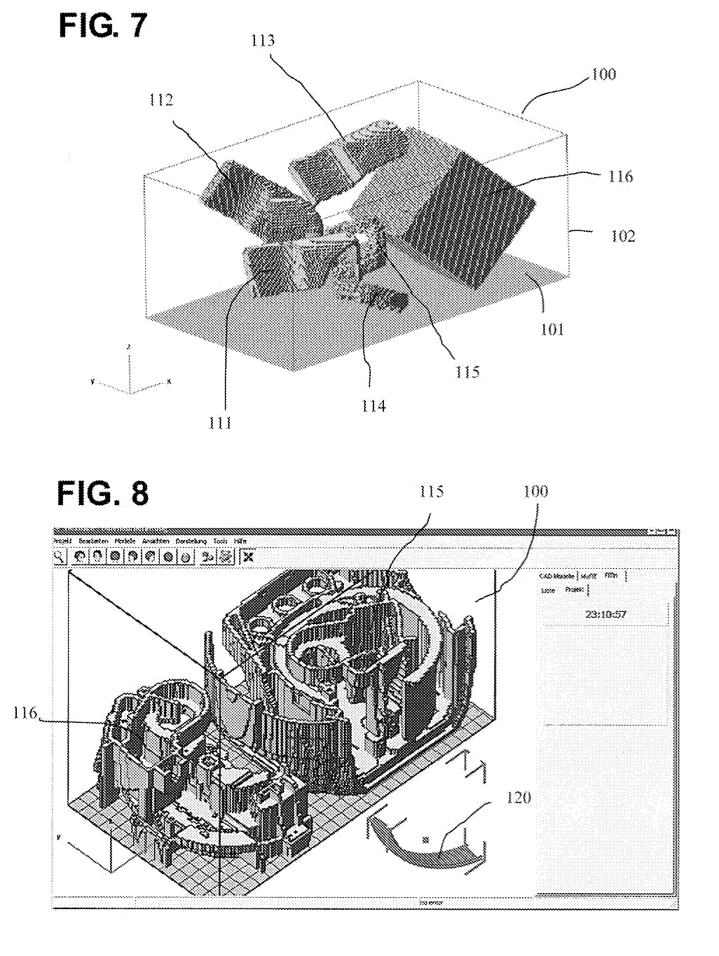

With reference to the schematic illustration in FIG. 1, a first exemplary embodiment of a manufacturing system according to the present invention is described. The manufacturing system comprises at least three manufacturing machines 10, 20, 30 that may be of the same type or of different types. The manufacturing machine 10 having the number 1 may, for example be a Rapid Manufacturing machine, which produces one or several parts in a construction space 100 (see, for example, FIG. 6 or 7) by hardening a plastic composition layer by layer. The manufacturing machine 20, which has the number 2 here, may be an identical machine but may also be a manufacturing machine that produces metal parts in a construction space by means of laser sintering or electron beam melting. A further manufacturing machine 30, which is denoted with the number 3 here, may, for example, be a known printing machine, which produces three-dimensional bodies by imprinting of paper.

In FIG. 1 several construction jobs 11-13, 21-23, 31-33 are assigned to each manufacturing machine 10, 20, 30. In the present case, one construction job 11-13, 21-23, 31-33 comprises a construction space of the respective manufacturing machine 10, 20, 30, wherein certain parts have to be manufactured. The nomenclature chosen in FIG. 1 means that in a first construction job No. 1, here marked with reference numeral 11, parts 111, 112, . . . 1nn are produced. The first numeral denotes the assignment to the manufacturing machine No. 1, the second numeral is the number of the construction job of this manufacturing machine No. 1, and the third numeral is the numeration of the part to be produced in this construction job (n ∈ N).

It should be noted that specific manufacturing data, like the kind of construction material used etc. are known and assigned to the manufacturing machine. Accordingly, a time in which time the manufacturing of all parts 111, 112, . . . nnn named and listed in the respective construction job is carried out, can be assigned to each construction job 11-13, 21-23, 31-33. Consequently an overview of the loading of the respective manufacturing machines 10, 20, 30 is known for a certain period of time. In particular it is known, how the individual manufacturing machines are charged. Moreover, all data relevant for the construction space, i.e., the size and position of the respective elements 111, 112, . . . is known.

The data representing the respective construction job 11-13, 21-23, 31-33 is stored in a central data base 40. This central data base 40 is in communication with each manufacturing machine 10, 20, 30. Different users 50 may have access to this central data base 40. In particular, it is possible that the users 50, which are potential ordering parties in this case, receive a visual display of the respective construction jobs 11-13, 21-23, 31-33, and for this purpose, a corresponding terminal 51 with display 52 may be assigned to each user. The communication with the central data base 40 may be effected via the internet or via other known communication channels. As shown, an anonymization module 45 may be additionally provided, which module serves for modifying the part data and therefore modifies the graphical representation of the parts on a display 52.

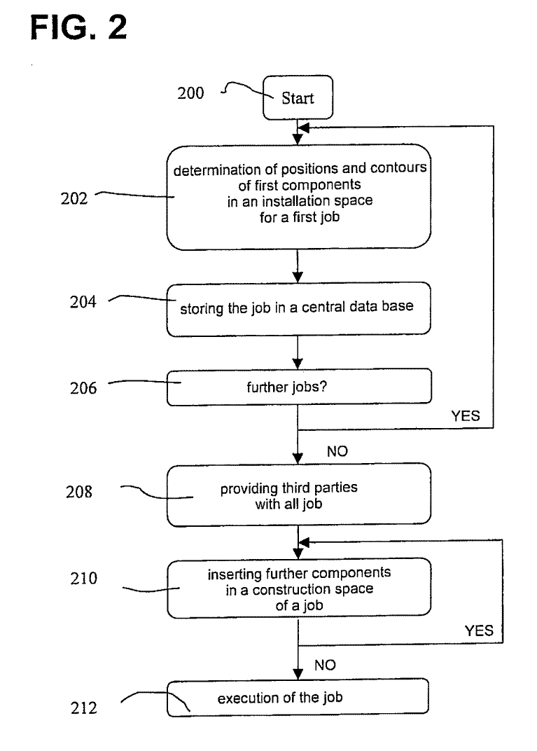

A first exemplary embodiment of a method according to the invention will now be explained with reference to FIG. 2. The basic procedure is started with process step 200. In process step 201, the positions and contours of first parts in a construction space for a first construction job 11-13, 21-23, 31-33 are determined. This construction job 11-13, 21-23, 31-33 may be any construction job of one of the manufacturing machines 10, 20, 30. In other words, in process step 202, a data collection is carried out, which comprehensively determines first parts to be manufactured in a manufacturing machine 10, 20, 30. As soon as the first parts for this construction job 11-13, 21-23, 31-33 are determined, said construction job is stored in the central data base in step 202. In the further process step 204 it is asked, if further construction jobs 11-13, 21-23, 31-33 are on hand. If there are further construction jobs, the sequence of process steps 202 to 204 is passed through again. Otherwise the existing construction jobs are stored in the data base 40.

After all construction jobs 11-13, 21-23, 31-33 have been executed, these construction jobs are then provided to third parties 40, i.e., the users 50, in any form by electronic means. This means that the users 50 have access to this data of the central data base 40 and, in particular, that they can have visually displayed in 3D the respective construction job with the first parts positioned therein in exemplary embodiments on a monitor, remote from the actual manufacturing plant with the manufacturing machines 10, 20, 30, and, in particular, can virtually examine these construction spaces of the individual construction jobs 11-13, 21-23, 31-33 from different perspectives, so that in particular the positions and the contours of the first parts in the respective construction spaces can be identified by the users 50. Therefore, for the first time ever, a user has the possibility to insert further parts to be manufactured into existing construction jobs 11-13, 21-23, 31-33, in the respective construction space of the respective construction job. This insertion step is denoted with reference numeral 210 in the flowchart according to FIG. 2. After the user 50 has inserted all his further parts into the respective construction jobs, the respective construction job 11-13, 21-23, 31-33 is then executed and the first and further parts are manufactured in the manufacturing machine 10, 20, 30. After the insertion of a further part in step 210, this insertion sequence 210 is passed through again, in case that further parts have to be inserted into further construction jobs or into the same construction job.

The basic advantage of the present invention may be that, for the first time ever, construction jobs 11-13, 21-23, 31-33 for potential ordering parties, i.e., users 50, are available and that the users 50 can check whether further parts can be inserted into a construction job 11-13, 21-23, 31-33, which may reduce the production time for the further parts and may also have the advantage that the user 50 does not have to wait until all construction jobs for the respective manufacturing machine 10, 20, 30 are executed before he may initiate a new construction job.

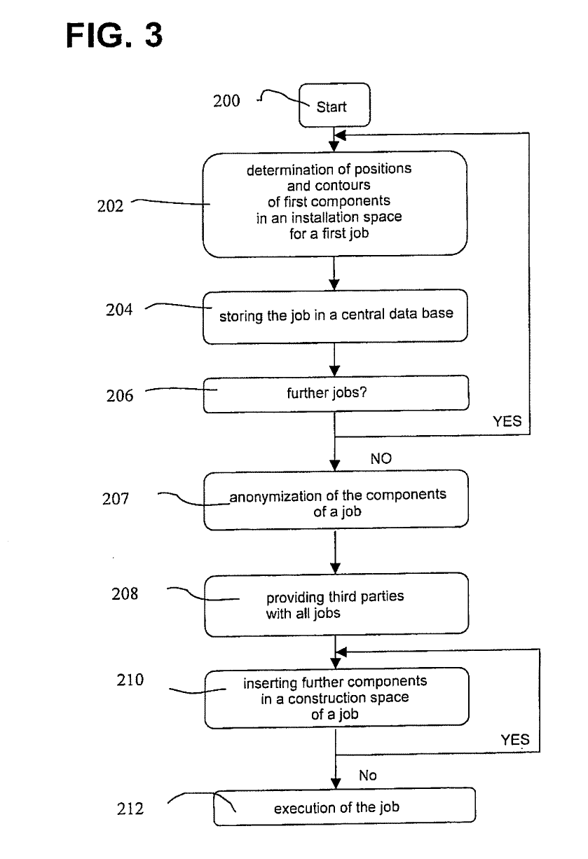

A further exemplary embodiment of the present invention is shown in FIG. 3 in form of a flowchart. Basically, the flowchart according to FIG. 3 is identical to that of FIG. 2. However, the intermediate step 207 is included, which step precedes the step of providing the user 50 with all construction jobs, according to the process step 208. To avoid unnecessary repetition, it is referred to the above explanations with regard to FIG. 2 process steps 202, 204, 206, 208, 210 and 212.

Therefore, an anonymization step 207 is carried out according to FIG. 3, after it has been asked in step 206, if further construction jobs according to process steps 202, 204 have to be executed according to process steps 202, 204,. An anonymization step comprises the modification of the first parts of a construction job 11-13, 21-23, 31-33 of a manufacturing machine 10, 20, 30 before users 50, i.e., in particular to external users 50, are provided with these construction jobs. The modification of part data is intended to avoid that the users 50 receive relevant information about the first parts of a construction job 11-13, 21-23, 31-33. For example, anonymization via Voxeln is carried out. With regard to the Voxeln it is, for example, referred to the thesis No.1662, “Generierung, Darstellung und Interaktion mit Voxel”, Stefan Häuser, 1998,University of Stuttgart, information technology faculty. Incidentally, further technical literature regarding the topic of Voxeln is available. Via Voxeln, volume comprising parts of a construction job are split into individual adjacent three-dimensional Voxels (Teilvolumina) in the form of cubes, rectangles or other geometrical forms, so that finally, on the display of a user 50, only very rough contours of these parts in a construction job are visually displayed and consequently details regarding these first parts of a construction job are not available for another user 50 who is not the ordering party for these construction jobs and the parts included therein. The anonymization may also be achieved by creating a rough encasement around the part to be manufactured, so that only the position and a very rough contour of the part are still visible for the user 50. Appropriate mathematical methods are sufficiently known to a skilled person and do not require further explanation.

In the exemplary embodiment of a method according to the invention, as is illustrated in FIG. 3, contrary to the method according to the exemplary embodiment of FIG. 2, not every first part in a construction job is visually and in detail displayed for a user 50, but only their rough contour or encasement is displayed, so that the potential ordering party 50 of further parts does not have access to details of the first parts of the respective construction jobs. Everything else remains unchanged. Despite the anonymization step 207 according to the exemplary embodiment of FIG. 3, a potential ordering party 50 may insert further parts into one or several construction jobs 11-13, 21-23, 31-33 before these construction jobs 11-13, 21-23, 31-33 are then executed and consequently all first and second parts of a construction job are consequently manufactured in a manufacturing machine 10, 20, 30.

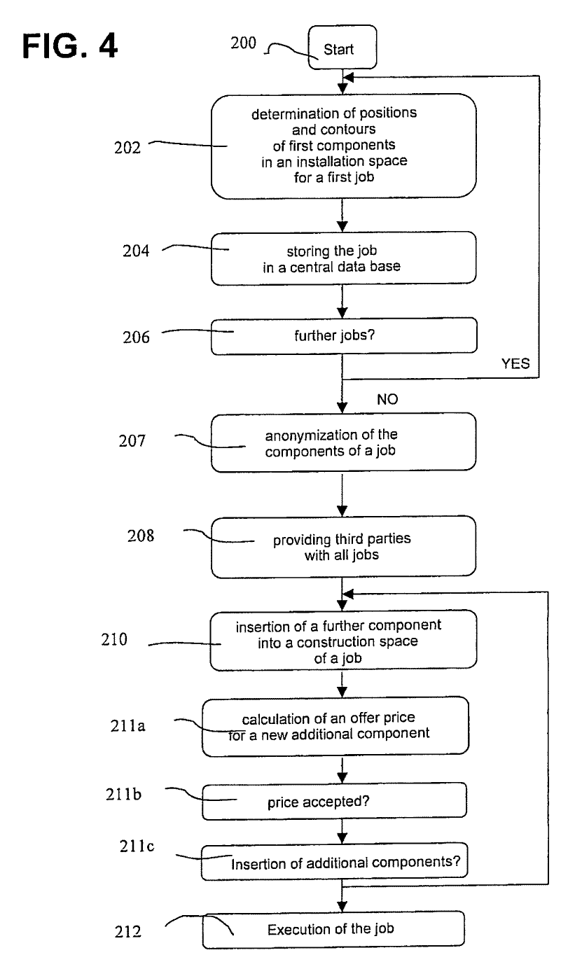

A further exemplary embodiment of a method according to the invention is shown in FIG. 4 in the form of a flowchart. The basic setup of this method corresponds to that of the method shown in FIG. 3 in the form of a flowchart. The process steps 211a-211c are, however, included between the known method steps 210 and 212. With regard to the known method steps of the flowchart of FIG. 4, in order to avoid unnecessary repetitions, it is referred to the corresponding embodiments of FIG. 3 with the same reference numerals.

In step 211a of this embodiment according to FIG. 4, an offer price for the new further part is issued, taking into account the first parts to be manufactured in the same construction job 11-13, 21-23, 31-33. Therefore, for the first time ever, a user 50 can obtain a current offer price for a further part, which the user 50 integrates into an existing construction job 11-13, 21-23, 31-33, wherein all parts to be manufactured in the construction job are taken into account in the pricing. Due to the fact that instead of only the first part also one or several further parts are manufactured in one construction job 11-13, 21-23, 31-33, the total manufacturing costs are more favourable than in a case where only the one further part is manufactured. If desired, the service provider may therefore pass on part of or the entire favourable manufacturing coats to the further user 50, who places the order for the new further part.

In step 211b, the user 50 is asked to enter, whether the offer price for the new further part is acceptable. If this is the case, it is asked in step 211c, whether another new further part has to be inserted into this construction job or into another construction job. If this is negated, then the construction job(s) according to step 212 is carried out and the further part(s) is/are then also created in the respective construction job.

In case that the query in step 211b results in the offer price being not acceptable, then the new further part that was inserted in step 211a is removed from the virtual construction job and is stored, unmodified, in the central data base, so that other users 50 may see the original construction space with the first parts originally placed therein. In case that the new further part has been inserted due to acceptance of the price in step 211b, this construction job including the first parts as well as the newly inserted further parts are visually displayed to further users 50.

In addition, it has to be stated that for all above mentioned embodiments of a method according to the invention the construction jobs 11-13, 21-23, 31-33 are only made available for users 50 in the data base 40 for a certain time until manufacturing is started. Then these construction jobs, which are actually in process at this time, and in which construction jobs no further parts can be inserted, are deleted from the data base 40.

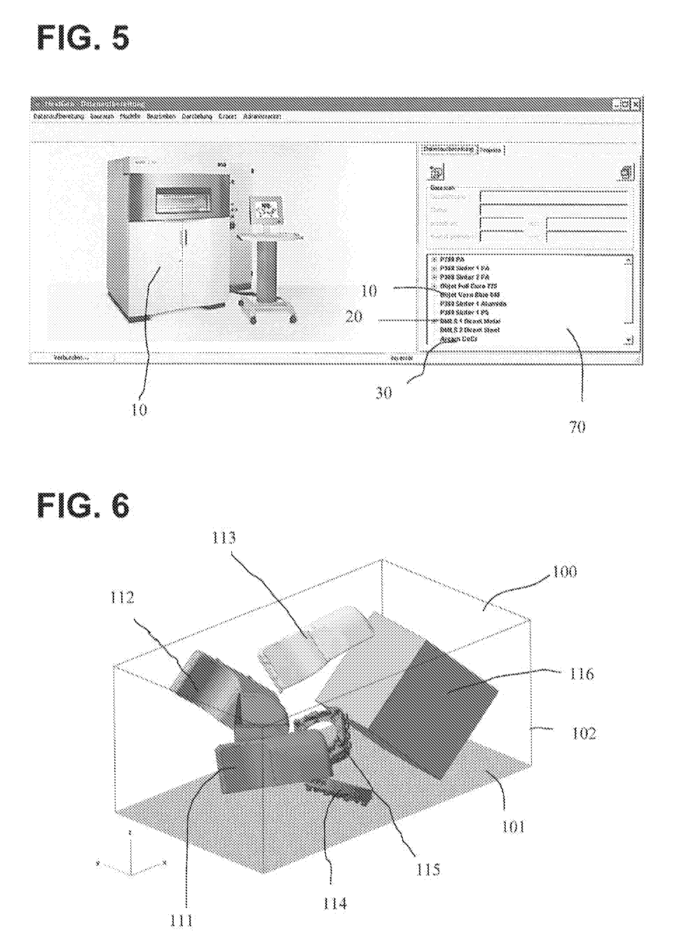

FIG. 5 is an exemplary embodiment of a display on a monitor 52, showing how the query in the flowchart of FIGS. 2 to 4, regarding a manufacturing machine 10, 20, 30, could look like for a user 50. According to FIG. 5, the display 52 shows a manufacturing machine 10 and the info box 70 shows a choice of the manufacturing machines 10, 20, 30 to be considered. By clicking on one of the manufacturing machines 10, 20, 30 etc., a user 50 then may select the desired manufacturing machine 10, 20, 30. After this selection process is finished, the respective construction jobs 11-13, 21-23, 31-33 of the respective manufacturing machine 10, 20, 30 are displayed to the user.

FIG. 6 schematically illustrates a three-dimensional perspective view a construction space 100 of a construction machine 10. Here, the construction space 100 has an oblong-shaped outline 101 and a defined height 102. This construction space 100 comprises first parts 111-116 to be manufactured therein. Due to the respective manufacturing method these first parts 111-116 may have any position within the boundaries of the construction space 100. Here, for example, the position of the first parts 111-150 in the construction space 100 is determined via a Cartesian coordinate system. For that purpose, each part 111-116 in the Cartesian coordinate system x, y, z has determined coordinates. The above mentioned digital part data with regard to the position may, of course, be dependent on the respective chosen coordinate system. Usually, however, a Cartesian coordinate system is used. It is, however, pointed out, that also other kinds of coordinate systems may be used for determining the position of the respective parts 111-116.

FIG. 6 shows a construction space 100 of one of the manufacturing machines 10, 20, 30. This illustration, however, represents a construction space that has not been anonymized like mentioned above with regard to FIG. 1. The illustrated construction job comprises the construction space 100 with the first parts 111-116 positioned therein.

FIG. 7 shows a construction job according to FIG. 6, the first parts 111-116 positioned therein and anonymized according to process step 207 (see above explanations regarding FIGS. 3 and 4). Here, the anonymization has been carried out via rasterizing or Voxeln of the parts 111-116. As can be seen from a comparison of FIG. 7 and FIG. 6, the individual parts 111-116 are not shown in detail, but only their rough contour can be seen. Thus, no details regarded as secret by the respective ordering parties of the first parts 111-116 are passed on to unauthorized parties.

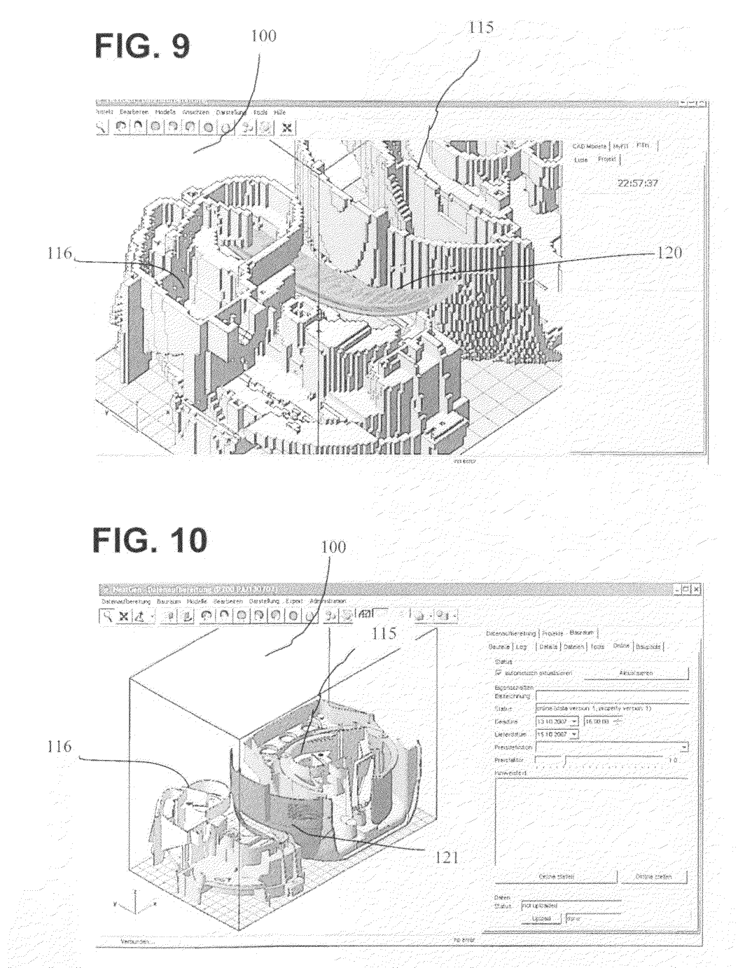

FIG. 8 shows a view of monitor 52 of a construction space or a construction job according to process step 208 (see explanations regarding FIG. 2). In the view shown in FIG. 8, the user 50 has access to all details of the first parts 111. An anonymization has not taken place here. According to FIG. 7, however, it could precede this step. In FIG. 8, the further part 120, which is desired by the user and is to be ordered by the user, is also illustrated, and the user 50 now tries to insert it into the virtual construction job according to FIG. 8. A view of the inserted further part 120 in the construction space 111 is shown in FIG. 9.

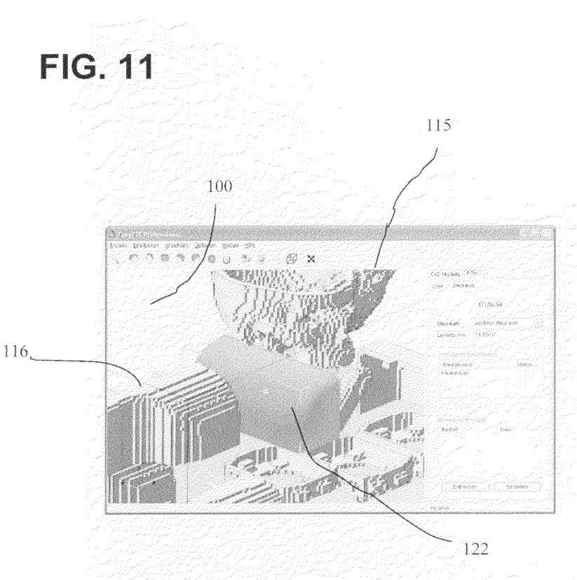

FIG. 10 shows a similar view according to FIGS. 8 and 9, where another additional part 121 is inserted between two first parts 111. The illustration of FIG. 11 corresponds to that of FIG. 10, wherein a user inserts an additional part 122 between first parts 111. Thus, the illustration according to FIG. 11 symbolizes a construction job different from that of FIGS. 8 to 10.

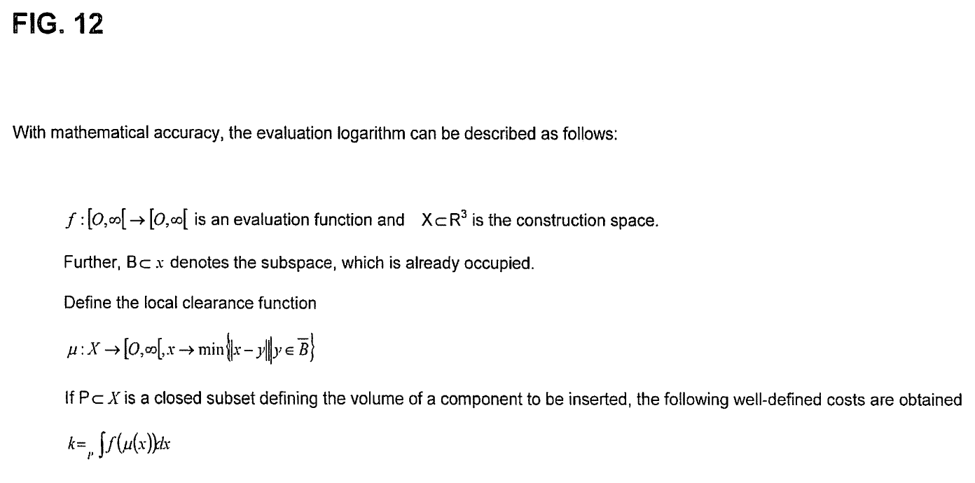

FIG. 12 relates to an exemplary evaluation function for calculating the production costs of one or several parts. Here, the construction space 100 is subdivided into individual cells. A value is assigned to each cell. The value of a free cell, i.e., a cell that does not comprise a part of a part, is set to be the higher, the further the distance between this free cell and a part or its outer contour. The sum of all cells then results in a value from which, amongst others, the manufacturing costs of a part, the process safety etc. may be derived. The lower the sum of all values of all cells of a construction space is, the lower, for example, the manufacturing costs per part will be, as the load factor of the construction space is optimized.

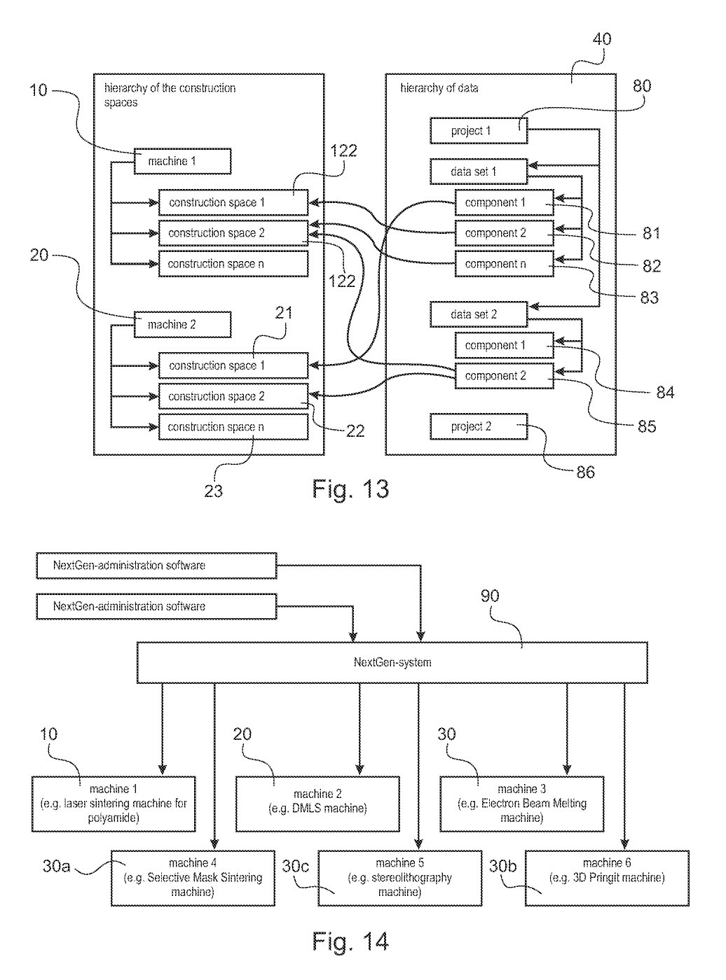

FIG. 13 shows a further schematic illustration of the elements and the data of the embodiment of a manufacturing machine according to the invention, shown in the embodiment in FIG. 1. Here, a machine 1 comprising construction spaces 1, 2, . . . n is provided. Here, the construction spaces 1, 2, . . . n are identical to the above mentioned construction jobs. A machine 2 comprises virtual construction spaces 1, 2, . . . n, which construction spaces have different construction jobs according to the above embodiments of manufacturing machine 2. The right hand side according to the illustration of FIG. 13 shows part of the data base 40. Thus, according to a project 80 parts 1, 2, . . . n, here marked with the reference numerals 81-85, have to be manufactured. The owner of the manufacturing machines 10, 20 distributes these 81-85 parts to the different construction spaces 11, 12, 13, 21, 22, 23 and subsequently, as symbolically shown in FIG. 1, the parts are stored in the central data base 40 where they are available for the user 50 (anonymized or not anonymized, depending on the user and/or depending on the construction job 11, 12, 13, 21, 22, 23).

FIG. 14 symbolizes the complete system of a manufacturing machine of this kind, which is provided with the adequate software. Here, the manufacturing machines are denoted by the reference numerals 10, 20, 30, 30a-30c. All manufacturing machines 10, 20, 30, 30a-30c are different from each other. The manufacturing machine 10, for example, is a laser sintering machine for polyamide. The manufacturing machine 20 is a DMLS-machine. The manufacturing machine 30 is an Electro Beam Melting machine. The manufacturing machine 30a is a Selective Masque Sintering machine. And the manufacturing machine 30b is a 3D Printing machine. Finally, the manufacturing machine 30c is a commonly known stereolithography machine. All of these manufacturing machines 10, 20, 30, 30a-30c are installed in a complete system by means of administration software, into which the data base 40 is also integrated.

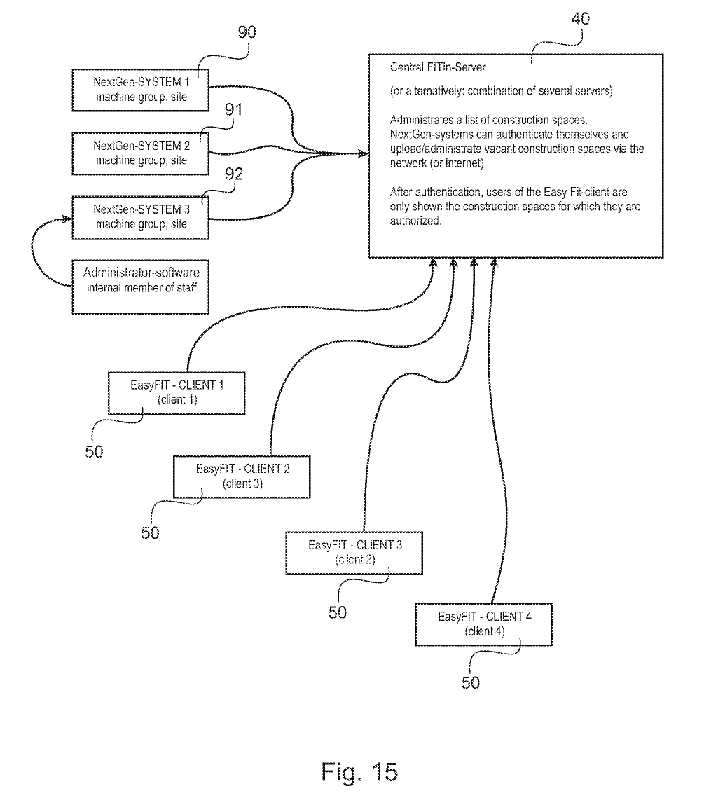

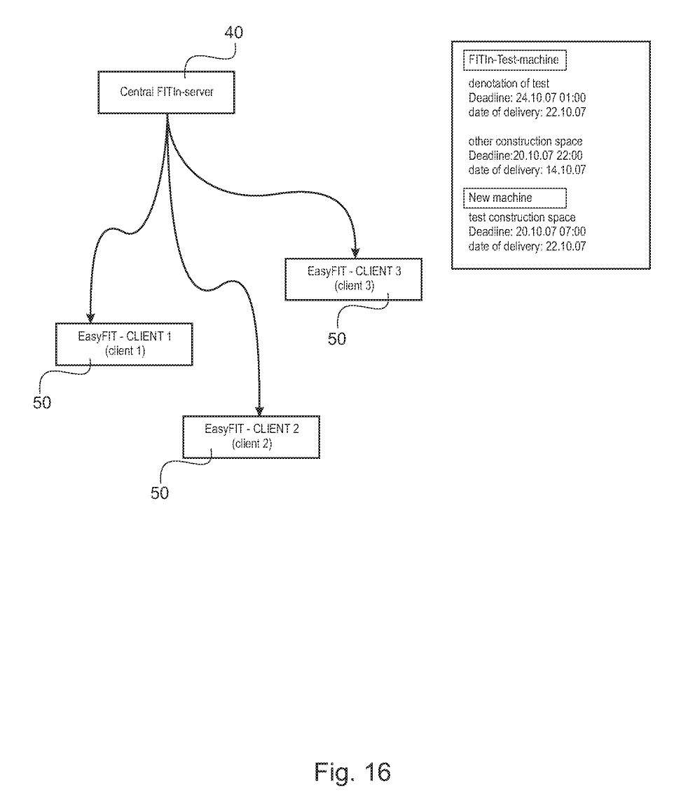

The further FIGS. 15 and 16 merely show the basic network structure. In FIG. 15, the central data base 40 exists on a server, which is termed “FITin-server” here. This central FITin-server with database 40 is connected to various NextGen-systems 90, 91, 92. As has been already explained with regard to FIG. 14, each NextGen-system 90, 91, 92 is connected to different machines or manufacturing machines 10, 20, 30, 30a-30c. Each NextGen-system 90, 91, 92 creates the technical preconditions regarding software and hardware, to administrate the machine-specific data of the individual manufacturing machines 10, 20, 30, 30a-30c and to place the first parts 111-116 into the individual construction spaces or construction jobs. Thus, generally, service providers may be provided with the NextGen-system, as each NextGen-system is highly dependent on the manufacturing machines 10, 20, 30, 30a-30c connected thereto. Basically, however, it is also possible to store the appropriate software of the service provider on another server.

Finally, according to FIG. 15, the respective construction jobs of each NextGen-system 90, 91, 92, that have been explained in detail above, are transferred to the central FITin-server with database 40, to which server various users 50, here named “EasyFIT-Clients” have access. By means of the terminals assigned to the respective users 50, the users 50 may insert further parts 120, 121, 122 into the construction jobs stored in the central data base 40.

In particular in FIG. 16, this process is again schematically illustrated. Here, the respective available construction jobs are transferred to each EasyFIT-user 50 by the central FITin-server with data base 40, which is shown in the box 41 on the right hand side.

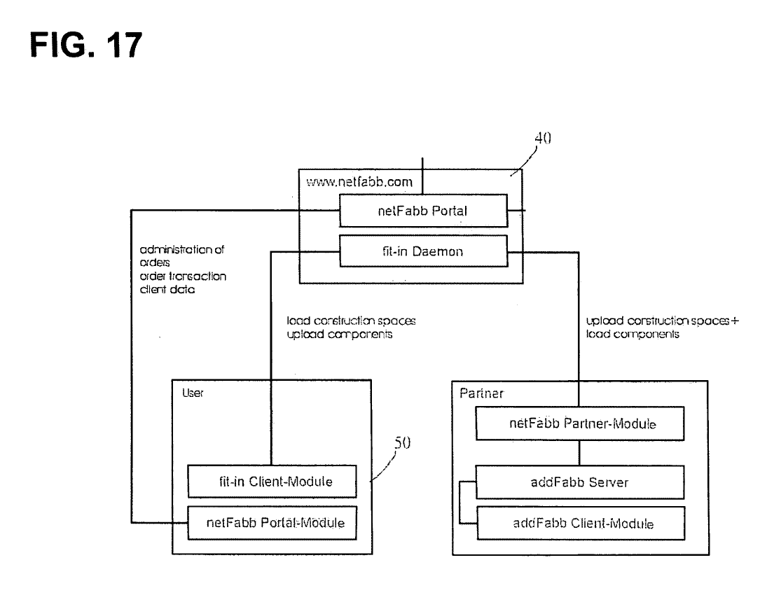

FIG. 17 finally shows the schematic exemplary installation and the cooperation of different modules and servers, which are able to implement exemplary embodiments of a manufacturing system according to the invention. The system that is shown here is divided into three separable fields:

### 1. User

The user (ordering party the User 50) is has a terminal 51 with a program that is here called “FITin Client program”. By means of the terminal 51, the user 50 obtains a construction space (construction job) that is provided “online” from a “FITin Daemon”, for example via an internet connection, as well as an evaluation function for this construction space. The user 50 positions his parts to be manufactured into the free spaces in the construction space. A “FITin Client Program” calculates the manufacturing costs by means of an evaluation function (see, for example, FIG. 12). The part data as well as the transformation matrix of the position and the calculated costs are transferred to the FITin Daemon, for example, via the internet. In predetermined time intervals, (e.g., a few seconds or minutes), the FITin Client Program checks whether a new version number of the construction space is available. If so, a new version is loaded. The order and administration of the order traditionally takes place via a web portal. This portal may be integrated into the FITin Client Program.

2. Internet server

A server on the internet runs a web portal for carrying out the commercial processes like ordering, issuing an invoice, confirmation of order, evaluation of customer satisfaction etc. On this server, a FITin Daemon process is provided, which on inquiry sends online construction spaces and evaluation functions to registered FITin Clients. The FITin Daemon receives these construction spaces and evaluation functions from an authorized, i.e., approved “addfabb-netfabb” partner module. When a part is sent by the user, the Client checks if the cost evaluation is correct and if this space is actually free. The sent part is sent to the partner. The part is also anonymized and inserted into the construction job. The version number of the construction job is increased by one, and the updated construction job is distributed to all connected FITinClients.

### 3. Partner

Usually, the partner is a plant operator and the addfabb-program is directly connected to the manufacturing system. In order to efficiently operate a plurality of parts via several members of staff, several machines and, over a long period of time, the addFabb-software is designed as a Client/Server program. Via an addFabb-Client program, the operator places first parts into the construction space and defines an evaluation function. These construction spaces may be posted online by the partner, and are then sent to the FITin Daemon in an anonymized form. To the partners, parts inserted by the users are displayed in the construction space without being anonymized. Parts added to the construction space by the partner, while a construction space is online, are synchronized with the FITin Daemon, in order to always provide an updated version of the construction space on the FITin Daemon.

What is claimed is:

1. A method for manufacturing at least one first part and at least one further part in a manufacturing machine including a defined construction space for manufacturing parts, the method comprising the steps of:
providing position and contours of the at least one first part positioned in the construction space as digital first part data;
providing digital construction space data representing the construction space;
providing the digital first part data and the digital construction space data representing the construction space to a potential ordering party for displaying the at least one first part in the construction space;
receiving digital second part data representing the at least one further part and its position in the construction space, the digital second part data being generated by displaying the construction space and the at least one first part and its position in the defined construction space and virtual positioning of at least one other part which was not yet commissioned in the displayed construction space;
manufacturing the at least one first part and the at least one further part in the manufacturing machine.

2. The method as recited in claim 1 further comprising:
displaying the construction space and the at least one first part and its position in the defined construction space;
virtual positioning the at least one other part which was not yet commissioned in the displayed construction space;
detecting digital second part data representing the at least one further part which was virtual positioned, and its position in the construction space; and,
transmitting the digital second part data of the at least one further part positioned in the construction space to the manufacturing machine.

3. The method recited in claim 1 including a further step of checking whether the remaining free space in the defined construction space of the manufacturing machine suffices to manufacture the at least one further part.

4. The method recited in claim 1 including a further step of anonymizing the at least one first part before displaying it.

5. The method recited in claim 1 including a further step of determining an access authorisation to the digital first part data and providing the digital first part data only for an ordering party of these parts.

6. The method recited in claim 4 including a further step of displaying the defined construction space and the at least one first part placed therein in an anonymized form for a second ordering party, which second ordering party is not the first party ordering the at least one first part.

7. The method recited in claim 1 including further steps of:
determining all first parts and all further parts; and,
recalculating manufacturing costs of each individual part to be manufactured in the defined construction space of the manufacturing machine, taking into account all determined first and further parts.

8. The method recited in claim 1 further comprising the steps of:
providing several manufacturing machines to a potential ordering party; and,
selecting a certain manufacturing machine from the several manufacturing machines by the potential ordering party.

9. The method recited in claim 1 including a further step of selecting a certain construction space from a plurality of construction spaces of a certain manufacturing machine.

10. A method for anonymization of at least one part positioned in a construction space of a manufacturing machine and ordered by a first ordering party, the method comprising the steps of:
providing position and contours of the at least one first part in the construction space as digital first part data;
altering the digital first part data so that at least the contours of the at least one first part are anonymized and consequently rendering of the at least one first part is amended and at least real contours of the at least one first part are not available anymore; and,
making available the altered digital first part data to potential second ordering parties, the potential second ordering parties being not identical with the at least one first ordering party.

11. The method recited in claim 10 wherein the anonymization of the contours of the at least one first part is carried out by Voxeln.

12. A manufacturing system for manufacturing at least one first part and at least one further part, comprising:
at least one manufacturing machine having a defined construction space wherein parts can be manufactured;
a distribution system, which is connected to the at least one manufacturing machine, the distribution system being configured to administrate digital data of construction spaces of each manufacturing machine and of digital first part data of at least one first part to be manufactured in a respective construction space; and,
a receiving device configured to receive digital further part data, the digital further part data representing the at least one further part and its position in the construction space and being generated by displaying the construction space and the at least one first part and its position in the defined construction space and virtual positioning of at least one further part which was not yet commissioned in the displayed construction space.

13. The manufacturing system recited in claim 12, further comprising:
at least one user terminal being connected to the distribution system, the user terminal comprising:
a displaying device configured to display, in particular in 3D display, one or several construction spaces with the at least one first part to be manufactured therein;
an input device configured to position at least one further part into a construction space displayed by means of the displaying device, in which construction space the at least one first part is positioned; and
a transmitting device configured to transmit the digital further part data.

14. The manufacturing system recited in claim 12, further comprising an anonymization device being connected to the distribution system, the anonymization system being configured to modify the digital first part data such that the at least one first part to be manufactured is anonymized.

15. The manufacturing system recited in claim 14, wherein the anonymization device is configured to anonymize the contours of the at least one first part by altering voxels.

16. The manufacturing system recited in claim 12, further comprising a cost calculation device, the cost calculation device calculating manufacturing costs of the at least one further part on the basis of all first and further parts to be manufactured in the same construction space.

17. The manufacturing system recited in claim 12, further comprising a testing device, the testing device checking by means of the digital first part data of all first parts in a construction space whether the remaining free space in the construction space suffices for manufacturing the at least one further part.
